(19) United States
(12) Patent Application Publication
(10) Pub. No.: US 2011/0288968 A1
(43) Pub. Date: Nov. 24, 2011

(54) PROCESSES AND APPARATUS TO GENERATE CROSS CHARGE AND RECOVEIES FOR SHARED SERVICE CENTERS

(75) Inventors: Nigel King, San Mateo, CA (US); Daniela Kantorova, Belmont, CA (US)

(73) Assignee: Oracle International Corporation, Redwood Shores, CA (US)

(21) Appl. No.: 12/784,033

(22) Filed: May 20, 2010

(51) Int. Cl. G06Q 10/00

(52) U.S. Cl. 705/30

(57) ABSTRACT

Aspects of the present invention provide tools and techniques that facilitate the process of accounting for shared services in an enterprise application. More specifically, in some aspects, certain embodiments employ a service provider model that codifies best practices in accounting for shared services and makes these practices part of setting up the shared service center, clients and outsourced business functions within an enterprise application. In an aspect, one set of embodiments uses the formal definition of service provider and client relationships between business units for the provision of specific business functions to generate cross charges to the client business unit and recoveries to the service provider business, unit based on the proportion of total service provided to the client.

### CROSS-REFERENCES TO RELATED APPLICATIONS

This application relates to commonly-assigned U.S. patent application Ser. No. 12/192,418, Attorney Docket No. 021756-033200US, filed Aug. 15, 2008 by Bhatia et al. and titled “Enterprise Structure Configurator”, U.S. patent application Ser. No. 12,192,583, Attorney Docket No. 021756-033500US, filed Aug. 15, 2008 by King et al. and titled “Business Unit Outsourcing Model”, and U.S. patent application Ser. No. 12/195,070, Attorney Docket No. 021756-048500US, filed Aug. 20, 2008 by Kantarova et al. and titled “Automated Security Provisioning for Outsourced Operations”. The respective disclosures of these applications/patents are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to enterprise software applications and more particularly, to tools and techniques for accounting and providing for shared services within such applications.

### BACKGROUND

Many businesses (and other organizations) use software applications (and/or suites of such applications) to organize their business affairs, track business performance, and/or the like. Such applications (referred to herein as “enterprise applications”) are often quite complex, relying on numerous database tables to store and manage data for virtually every aspect of an organization's business. Merely by way of example, enterprise applications can include supply chain management (“SCM”) applications that manage raw materials, work-in-process and/or finished products, coordinate with suppliers, and/or the like; customer relations management (“CRM”) applications that are used to track, store and/or manage customer information; financial applications that track and/or analyze the financial performance of the organization; human resources applications that provide management of the human resources functions of the organization; and/or the like. In some cases, these enterprise applications are standalone applications; in other cases, a single enterprise application (and/or suite of applications) might provide some or all such functionality. One type of enterprise application is referred to enterprise resource planning (“ERP”) software. Examples of enterprise applications include, without limitation, JD Edwards EnterpriseOne™, PeopleSoft Enterprise™ applications, and the Oracle eBusiness Suite™, all available from Oracle Corporation.

For a variety of reasons, a modern business (or other organization) may be organized into several business units. (A “business unit,” as that term is used herein, means any group within a business that is viewed as a discrete entity for one or more purposes, such as for operational/functional distinctions, for financial responsibility, for managerial reporting, for legal reporting, and/or the like.) In an aspect, especially from the perspective of an enterprise application, a business unit might perform a variety of business functions (which can be represented by functions within the enterprise application, such as a payroll function, an accounts payable function, a sales order function, etc.).

As enterprises have grown more accustomed to managing their affairs with enterprise applications, process efficiencies and greater internal controls have lead many large enterprises to establish shared service centers to support a number of internal clients. For example, the payroll function of a particular business unit might provide such services not only for that business unit, but for other units within the enterprise as well. Enterprise applications, however, generally have not been designed to be used by one business unit of an enterprise while servicing many others. In many cases, the enterprise application could not be deployed in a manner that would support such a configuration.

Solutions have been proposed to provide enhanced flexibility and configurability when dealing with these types of situations. Merely by way of example, commonly-owned, copending U.S. patent application Ser. No. 12/192,418, Attorney Docket No. 021756-033200US, filed Aug. 15, 2008 by Bhatia et al. and titled “Enterprise Structure Configurator,” describes several tools for configuring an enterprise application to support a shared services model. Similarly, commonly-owned, copending U.S. patent application Ser. No. 12,192,583, Attorney Docket No. 021756-033500US, filed Aug. 15, 2008 by King et al. and titled “Business Unit Outsourcing Model,” describes tools for implementing a shared services model within an enterprise application. U.S. patent application Ser. No. 12/195,070, Attorney Docket No. 021756-048500US, filed Aug. 20, 2008 by Kantarova et al. and titled “Automated Security Provisioning for Outsourced Operations,” describes tools for implementing security considerations in a shared services model. Each of the foregoing applications is incorporated herein by reference for all purposes.

In a shared (outsourced) services model, one primary consideration is the allocation and recovery of costs associated with the shared service. More specifically, in a typical implementation, a provider business unit will provide services for one or more client business units within the enterprise, as well, in many cases for clients outside the enterprise. This provider business unit often will have costs associated with the services provided, and the allocation and recovery of those costs is an important consideration in ensuring the integrity of the enterprise's financial reporting and monitoring.

Unfortunately, when costs are born only by the business unit that is providing the shared services, the contribution of the commercial business and the performance of the service provider are difficult to measure. Traditionally, users of enterprise applications will generally have allocated costs using facilities within general ledger or specialized applications. These products are capable, but they need to be configured correctly. This is very specialized work, and in the past, it would require knowledge of best practices in accounting for shared services. It would require specialized capability in an accounting system and the knowledge of how to set it up to create the appropriate entries.

### BRIEF SUMMARY

Certain embodiments, therefore, provide tools and techniques that facilitate the process of accounting for shared services in an enterprise application. More specifically, in some aspects, certain embodiments employ a service provider model that codifies best practices in accounting for shared services and makes these practices part of setting up the shared service center, clients and outsourced business functions within an enterprise application. In an aspect, one set of embodiments uses the formal definition of service provider and client relationships between business an HR department is budgeted to spend $1000 per month which equates to per $10 per employee, but actually spends $2000 per month, the present invention provides the ability to configure the system to cross charge a client department at $10 per employee (i.e., the budgeted rate) or at $20 per employee (i.e., the actual rate).

Various embodiments can post transactions to statistical accounts in the general ledger system of the enterprise to account for costs and recoveries related to provided services, and/or create appropriate cross charge and recovery entries directly. In either case, the system can use this information to create the entries in the accounting system to charge the portion of the costs incurred by the shared service center to each client based on the percentage of the total transactions processed on behalf of each client. In an aspect, the system can be configured to cross charge for various services at either budgeted or actual rates, and/or at a marked up rate if desired.

In a sense, certain embodiments can deliver best practices in outsourcing and process standardization while building the cross charge and recovery model directly into the outsourcing model itself. With this capability, a user can both drive down the costs of administrative functions and at the same time measure the contribution of commercial business units and set targets for and measure the performance of service providers.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical and/or tangible computer readable media (such as, to name but a few examples, optical media, magnetic media, and/or the like).

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a system for accounting and providing for shared services, in accordance with various embodiments.

FIG. 2 is a process flow diagram illustrating a method of implementing a shard service center, in accordance with various embodiments.

FIG. 3 is a process flow diagram illustrating a method of implementing a service provider business unit, in accordance with various embodiments.

FIG. 4 is a process flow diagram illustrating a method of defining a client business unit, in accordance with various embodiments.

FIG. 5 is a generalized schematic diagram illustrating a computer system, in accordance with various embodiments.

FIG. 6 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Various embodiments provide tools and techniques that facilitate the process of accounting for shared services in an enterprise application. More specifically, in some aspects, certain embodiments employ a service provider model that codifies best practices in accounting for shared services and makes these practices part of setting up the shared service center, clients and outsourced business functions within an enterprise application.

In an aspect, one set of embodiments uses the formal definition of service provider and client relationships between business units for the provision of specific business functions to generate cross charges to the client business unit and recoveries to the service provider business unit. Such embodiments can take advantage of knowing the cost center that tracks the costs of the service provider and the cost center that bears the costs of the services provided. In an aspect, certain embodiments can also take advantage of knowing the type of transaction processed in the outsourced business function and how the transaction is represented in the business system of the enterprise.

Some embodiments can post transactions to statistical accounts in the general ledger system of the enterprise to account for costs and recoveries related to provided services. Other embodiments might create appropriate cross charge and recovery entries directly. In either case, the system can use this information to create the entries in the accounting system to charge the portion of the costs incurred by the shared service center to each client based on the percentage of the total transactions processed on behalf of each client. The system, in some embodiments, can employ information about service level agreements and or business unit budgets maintained within the enterprise application to be able to cross charge at either budgeted or actual rates. The system can also cross charge at a marked up rate if desired. In one aspect, tools provided by various embodiments can preconfigure the cost allocation set up between various client and provider business units. In another aspect, these tools can provide dedicated wizards to capture necessary information at the time of deployment, reducing the skills required to set up allocations, allowing a relatively unskilled user to declare the business outsourcing relationships that exist between business units.

In a sense, certain embodiments can deliver best practices in outsourcing and process standardization while building the cross charge and recovery model directly into the outsourcing model itself. With this capability, a user can both drive down the costs of administrative functions and at the same time measure the contribution of commercial business units and set targets for and measure the performance of service providers.

Hence, in an aspect, several embodiments allow for the imposition of cross charges and cross recoveries within an enterprise application. As used herein, the term “cross charge” means any amount that is charged against an account of a “client business unit” as payment and/or reimbursement to a “service provider business unit” for services provided (e.g., transactions processed) by the service provider business unit on behalf of the client business unit. As used herein, the term “cross recovery” is used to refer to an amount, corresponding to the cross charge, that is credited to an account of the service provider business unit. (As noted below, these accounts may be specialized cost and recovery accounts or the like).

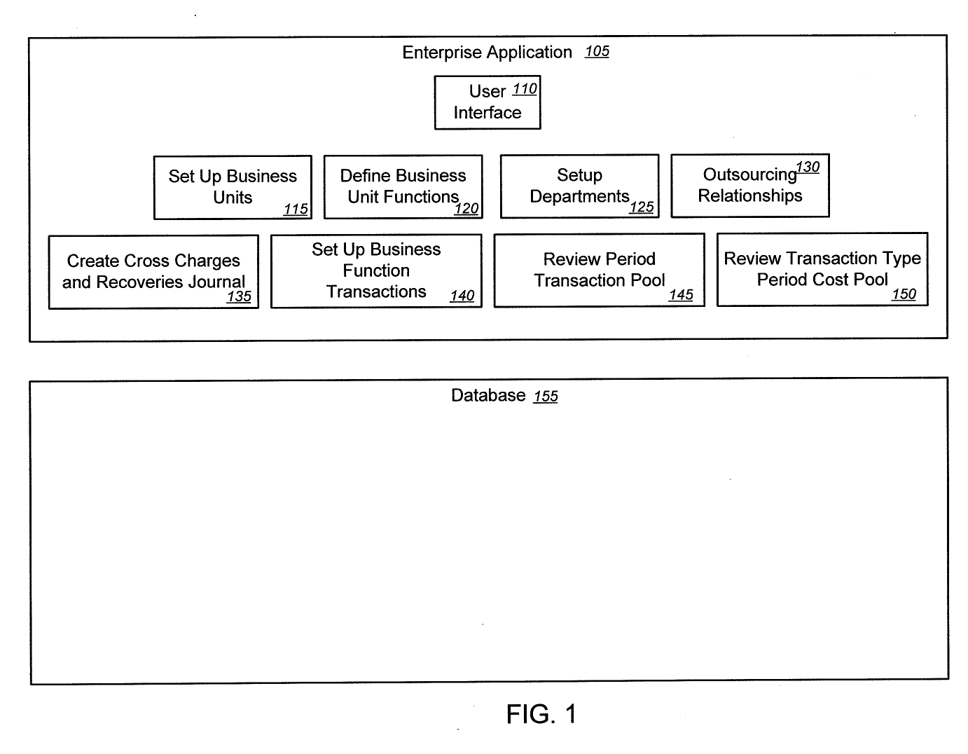

In a broad sense, certain embodiments may be implemented by a system such as the system 100 depicted by FIG. 1. In certain aspects, some embodiments may be implemented as a set of functional modules within an enterprise application 105. In an aspect, some or all of these models might provide user interface 110 elements for receiving user input and/or providing output. Merely by way of example, a module might provide a window with input fields (e.g., text entry fields, autopopulated pull-down boxes, etc.) to receive input from the user for configuring the enterprise application 105 for cross charges and recoveries. Advantageously, these modules may employ information already provided or resident in the enterprise application (or supporting database) to reduce the need for data entry and enhance data consistency.

In one embodiment, a set up business units module 115 may be configured to set up a business unit and state that some business functions may be outsourced to another business unit. For example, in order to set up an export business unit for a scientific instrument manufacturer, the payables invoice processing will be done through a domestic business unit, and a cost center will bear the cross charged costs. Further, a define business functions module 120 allows for the definition of the type of transaction that is used to fulfill the business function, the account credited in a service provider, the account charged in a client, the start of the account range that identifies the cost pool within which costs for this business function are collected, and the end of the account range that identifies the cost pool within which costs for this business function are collected.

Merely by way of example, a set up departments module 125 might allow for the definition of a business unit, and in accordance with certain embodiments, might allow the user to associate a business function with a particular business unit that provides that function. An outsourcing relationships module 130 might allow for the definition of a an outsourcing relationship in which a service provider business unit provides services for a client business unit. Such a module might also allow the definition (and/or memorialization) of a service level agreement (“SLA”) relationship between the two (or more) business units. That relationship might specify the cross charge basis (e.g., budget, actual, and/or markup), the cross charge instrument (e.g., invoice, journal, and/or statistical posting), terms that might be used in an audit, such as an SAS 70 audit, including internal controls commitments, and/or terms that can be used to judge performance of the provided services, such as time to issue resolution, availability, and/or the like.

Furthermore, a set up business function transactions module 140 might allow a user to define a type of transaction to be performed by a shared service (outsourced business function). Such a definition can include, without limitation, identification of the type of transaction that is used to fulfill a business function, the account to be credited at the service provider, the account to be charged at the client business unit, and/or an account (or range of accounts) that identify a cost pool from which costs for the business function are to be collected. An example might be the business function of “Payables Payment” with a transaction type of “Payables Checks,” with a cross charge account of “Department A Outsourced Charges” and a recovery account of “Department B Outsourced Recoveries” (where Department A is the client and Department B is the service provider).

A review transaction type period cost pool module 150 can be used to allow the user to review the cost pool of all accounts balances for accounts within the cost pool of a selected Business Function or its transaction type and Period. Additionally, a review transaction pool module 145 can be used to allow a user to review the total count of all transactions that have been processed by a service provider business unit and/or a subtotal of the transactions (e.g., a total of the transactions processed on behalf of each client). Within this module, the user can see the total costs in the cost pool for this service provider and this business function. Alternatively and/or additionally, the user can see the proportion of transactions performed on behalf of each client of the service provider, and/or can see the proportion of the total costs in the cost pool that accrues to each client. In some instances, this module can allow a user submit a cross charge and recoveries journal.

A create cross charges and recoveries journal module 135 (which might, as noted above, be invoked from another module, such as the review transaction pool module 145) can take the total of the account balances for the cost pool for a period and business function for service provider business unit and create a recovery entry credited to the recovery account, nominated on the transaction type for the business function. It creates this entry in the cost center that tracks costs for the department that performs the business function for the business unit. This module can also create cross charge entries for each client of the business function for the service provider, to the cross charge account also nominated on the transaction type for the business function. In an aspect, this module creates this entry in the cost center recorded on the outsourcing relationship. Furthermore, a database 155 may be configured to store information associated with each of the modules and the enterprise application 105.

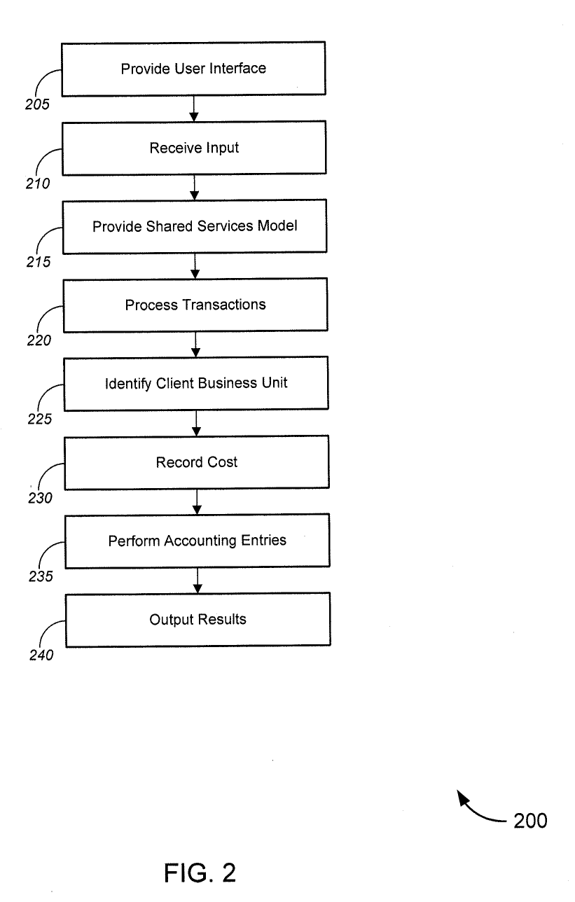

Turning now to FIG. 2, which illustrates a method 200 of implementing a shard service center. At process block 205, a user interface may be provided (e.g., user interface 110 from FIG. 1). In one embodiment, the user interface may be implemented on a computer, a mobile device, etc. The user interface may be configured to receive input for implementing the shared service center (process block 210). At process block 215, a shared services model may be provided.

At process block 220, initiation of a transaction in the shared service center and selection of the client business unit on behalf of which the transaction will be processed. For example, a manufacturer of scientific equipment with both a domestic and export business may choose to consolidate accounts payable processing in a single accounts payable (AP) department. An AP clerk is then able to register an invoice and choose the export business as the business unit on behalf of which the invoice will be processed.

Furthermore, set up of a client business unit occurs (process block 225). For example, some business functions may be outsourced to another business unit. Such as, setting up an export business unit for a scientific instrument manufacturer and the payables invoice processing will be done through a domestic business unit. Also, the cost center that will bear the cross charged costs should be recorded and established (process block 230).

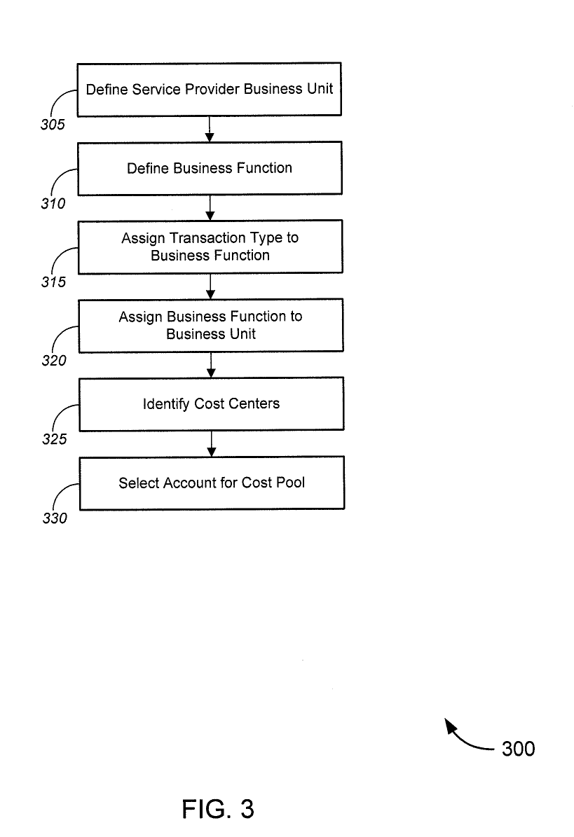

Referring next to FIG. 3, which illustrates a method 300 of implementing a service provider business unit. At process block 305, a service provider business unit is defined. In one embodiment, a service provider business unit is a business unit that will perform services on behalf of other business units. For example, a company in the scientific equipment business may have a dominant domestic business and a smaller export business. As such, a business unit at a headquarters could be set up which performs general administrative functions, such as payables invoice registration on behalf of both the domestic and export business units.

At process block 310, the business function of the service provider business unit may be defined. Further, a transaction type may be assigned to the business function (process block 315). In other words, assigning the business transaction that fulfills a business function. Information is stored that may be needed to cross charge for a transaction being performed in one business unit on behalf of another business unit. Accordingly, the business function may then be assigned to the business unit (process block 320).

Furthermore, at process block 325, cost centers may be identified, by selecting a department and identify the cost centers within the department which costs for that department are tracked. For example select a payables department and state that the costs will be tracked in cost centers USAP106 and USAP107. At process block 330, an account may be selected for a cost pool. In one embodiment, the cost pool includes the total costs that accrues to each client.

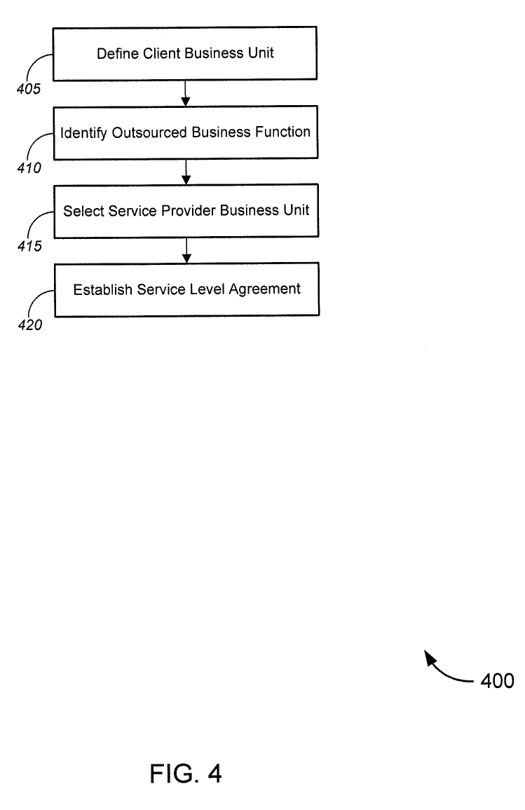

Tuning now to FIG. 4, which illustrates a method 400 of defining a client business unit. In one embodiment, a client business unit is a business unit for which some business functions are outsourced to another business unit (i.e., a service provider business unit). For example, an export business unit for a scientific instrument manufacturer may be set up such that the payables invoice processing will be done through a domestic business unit. In this situation the cost center bears the cross charged costs.

Accordingly, the outsourced business function is identified (process block 410). In one embodiment, the service level agreements for the outsourced business function are set up. Such agreements may include terms that will be used in cross charging (e.g., cross charge basis, budget or actual, cross charge instrument: invoice, journal or statistical posting), terms that will be used in SAS 70 audits (i.e., internal controls commitments), terms that will be used to judge performance (e.g., time for issues resolution, availability, etc.).

At process block 415, a service provider business unit used to provide the client business unit with the outsourced business functions. Accordingly, the above mentioned service level agreement may be established between the selected service provider business unit and the client business unit (process block 420).

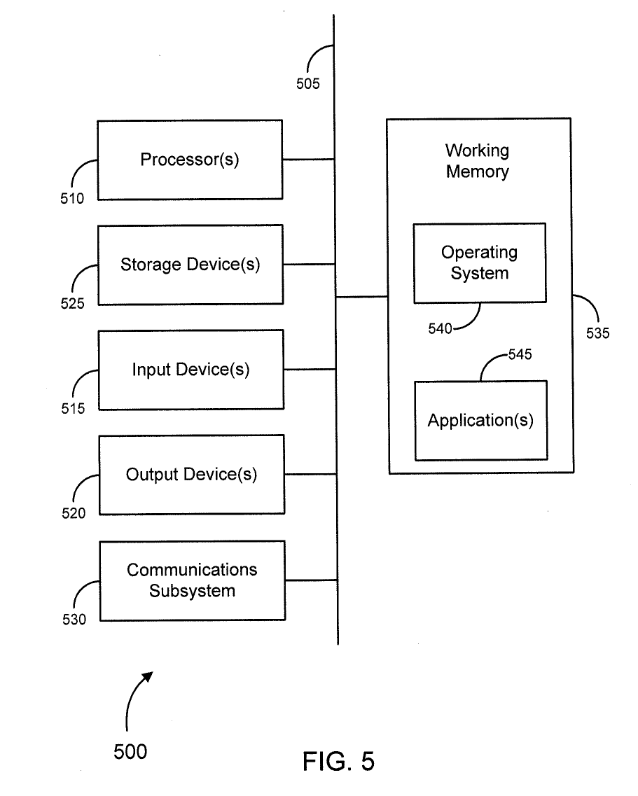

FIG. 5 provides a schematic illustration of one embodiment of a computer system 500 that can perform the methods provided by various other embodiments, as described herein, and/or can function as, for example, enterprise application 105, database 155, setup departments 125, etc. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer systems, and/or with any other devices described herein. In many embodiments, the computer system 500 will further comprise a working memory 535, which can include a RAM or ROM device, as described above.

The computer system 500 also may comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 500, various computer readable media might be involved in providing instructions/code to processor(s) 510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 525. Volatile media includes, without limitation, dynamic memory, such as the working memory 535. Transmission media includes, without limitation, coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

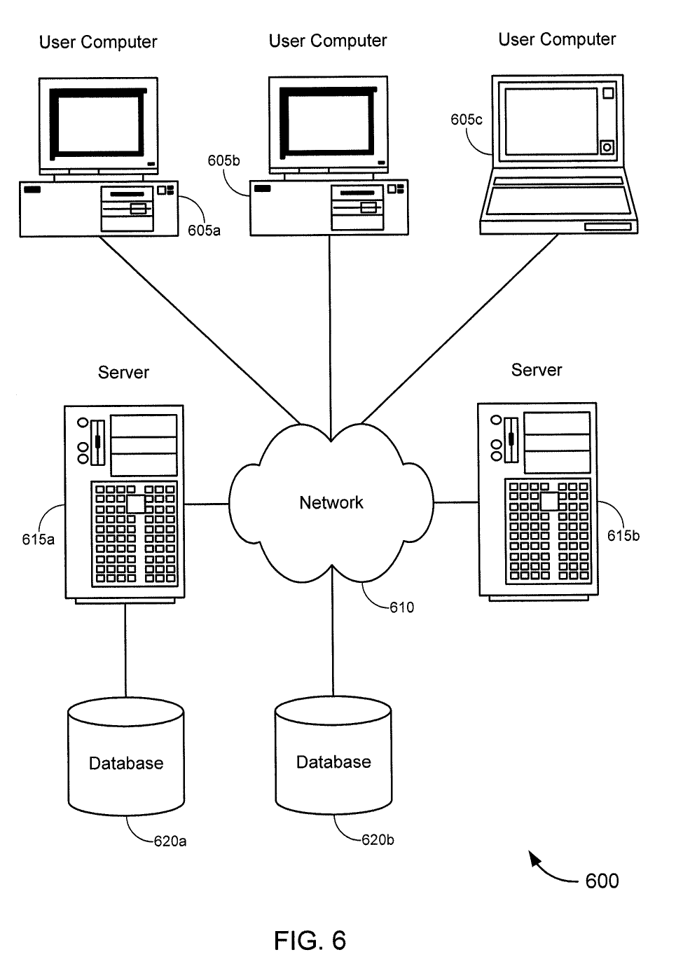

A set of embodiments comprises systems for implementing, for example, enterprise application 105, database 155, setup departments 125, etc. Merely by way of example, FIG. 6 illustrates a schematic diagram of a system 600 that can be used in accordance with one set of embodiments. The system 600 can include one or more user computers 605. A user computer 605 can be a general purpose personal computers (including, merely by way of example, personal computers and/or laptop computers running any appropriate flavor of Microsoft Corp.'s Windows™ and/or Apple Corp.'s Macintosh™ operating systems) and/or a workstation computer running any of a variety of commercially-available UNIX™ or UNIX-like operating systems. A user computer 605 can also have any of a variety of applications, including one or more applications configured to perform methods provided by various embodiments (as described above, for example), as well as one or more office applications, database client and/or server applications, and/or web browser applications. Alternatively, a user computer 605 can be any other electronic device, such as a thin-client computer, Internet-enabled mobile telephone, and/or personal digital assistant, capable of communicating via a network (e.g., the network 610 described below) and/or displaying and navigating web pages or other types of electronic documents. Although the exemplary system 600 is shown with three user computers 605, any number of user computers can be supported.

Certain embodiments operate in a networked environment, which can include a network 610. The network 610 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 610 can include a local area network (“LAN”), including without limitation an Ethernet network, a Token-Ring network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™ and the like, which can process requests from clients (including, depending on the configuration, dedicated database clients, API clients, web browsers, etc.) running on a user computer 605 and/or another server 615. In some embodiments, an application server can create web pages dynamically for displaying the information in accordance with various embodiments, such as user interface 110. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 635 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A computer system, comprising:
one or more processors; and
a computer readable medium in communication with the one or more processors, the computer readable medium having encoded thereon a set of instructions executable by the computer system to perform one or more operations, the set on instructions comprising:
instructions for providing, within an enterprise application, a shared services model comprising at least one service provider business unit and a plurality of client business units, wherein the service provider business unit provides a shared business function within the enterprise application to each of the plurality of client business units;
instructions for providing a user interface to receive user input for defining one or more components of the shared services model;
instructions for defining the service provider business unit, based on user input;
instructions for defining the shared business function;
instructions for assigning a transaction type to the shared business function;
instructions for assigning the shared business function to the service provider business unit, based on user input;
instructions for identifying a set of one or more cost centers for the shared business function, based on user input;
instructions for selecting an account to hold a cost pool for recording a cost to the service provider business unit of providing the shared business function;
instructions for defining one of the plurality of client business units, based on user input;
instructions for identifying the shared business function as an outsourced business function for the defined client business unit, based on user input;
instructions for selecting the service provider business unit as a provider of the outsourced business function;
instructions for processing, in the enterprise application, a plurality of transactions with the service provider business unit on behalf of the plurality of client business units, in accordance with the shared business function, wherein one or more of the plurality of transactions are of the assigned transaction type;
instructions for identifying, for each of the plurality of transactions, a client business unit associated with the transaction;
instructions for recording, in the enterprise application, a cost to the service provider business unit of providing the shared business function;
instructions for allocating the cost of the shared business function among the plurality of client business units; and
instructions for performing one or more accounting entries in one or more cross charge accounts within the enterprise application to charge an allocated portion of the cost to one or more of the plurality of client business units, based on the proportion of total service provided to the client;
instructions for performing, in a cross recovery account associated with the service provider business unit, one or more accounting entries, corresponding to the one or more accounting entries in the one or more cross charge accounts; and
instructions for outputting a record of the one or more accounting entries.

2. The apparatus of claim 1, wherein if one or more of the plurality of client business units is budgeted to spend a first amount per month which equates, and spends a second amount per month, the sets of instructions include instruction for configure cross charging the at least one of the plurality of client business units at the first amount or the second amount.

3. In an enterprise application, a method of allocating costs among business units, the method comprising:
providing, within the enterprise application on a computer system, a shared services model comprising at least one service provider business unit and a plurality of client business units, wherein the service provider business unit provides a shared business function within the enterprise application to each of the plurality of client business units;
processing, in the enterprise application, a plurality of transactions with the service provider business unit on behalf of the plurality of client business units, in accordance with the shared business function;
identifying, for each of the plurality of transactions, a client business unit associated with the transaction;
recording, in the enterprise application, a cost to the service provider business unit of providing the shared business function;
allocating the cost of the shared business function among the plurality of client business units; and
for performing one or more accounting entries in the enterprise application to charge an allocated portion of the cost to one or more of the plurality of client business units.

4. An apparatus, comprising:
a computer readable medium having encoded thereon a set of instructions executable by one or more computers to perform one or more operations, the set of instructions comprising:
instructions for providing, within an enterprise application, a shared services model comprising at least one service provider business unit and a plurality of client business units, wherein the service provider business unit provides a shared business function within the enterprise application to each of the plurality of client business units;
instructions for processing, in the enterprise application, a plurality of transactions with the service provider business unit on behalf of the plurality of client business units, in accordance with the shared business function;
instructions for identifying, for each of the plurality of transactions, a client business unit associated with the transaction;
instructions for recording, in the enterprise application, a cost to the service provider business unit of providing the shared business function;
instructions for allocating the cost of the shared business function among the plurality of client business units; and
instructions for performing one or more accounting entries in the enterprise application to charge an allocated portion of the cost to one or more of the plurality of client business units.

5. The apparatus of claim 4, wherein the instructions for providing a shared services model comprise:
instructions for defining the service provider business unit;
instructions for assigning the shared business function to the service provider business unit;
instructions for identifying a set of one or more cost centers for the shared business function; and
instructions for selecting an account to hold a cost pool for recording a cost to the service provider business unit of providing the shared business function.

6. The apparatus of claim 4, wherein the instructions for providing a shared services model comprise:
instructions for defining one of the plurality of client business units;
instructions for identifying the shared business function as an outsourced business function for the defined client business unit; and
instructions for selecting the service provider business unit as a provider of the outsourced business function.

7. The apparatus of claim 6, wherein the instructions for providing a shared services model further comprise:
instructions for establishing a service level agreement between the defined client business unit and the service provider business unit with respect to the outsourced business function.

8. The apparatus of claim 4, wherein the instructions for providing a shared services model further comprise:
instructions for defining the shared business function; and
instructions for assigning a transaction type to the shared business function, wherein one or more of the plurality of transactions are of the assigned transaction type.

9. The apparatus of claim 8, wherein the assigned transaction type is a first transaction type, and wherein the instructions for providing a shared business model further comprise:
instructions for assigning a second transaction type to the shared business function, wherein a second one or more of the plurality of transactions are of the second assigned transaction type.

10. The apparatus of claim 8, wherein the shared business function is a first shared business function and the assigned transaction type is a first transaction type, and wherein the instructions for providing a shared services model further comprise:
instructions for defining a second shared business function; and
instructions for assigning a second transaction type to the second shared business function.

11. The apparatus of claim 10, wherein the instructions for providing a shared services model further comprise:
instructions for assigning the second shared business function to the service provider business unit.

12. The apparatus of claim 10, wherein service provider business unit is a first service provider business unit, and wherein the instructions for providing a shared services model further comprise:
instructions for assigning the second shared business function to a second service provider business unit.

13. The apparatus of claim 12, wherein the instructions for providing a shared services model further comprise:
instructions for selecting the second shared business function as an outsourced business function for the first service provider business unit, so that the first service provider business unit is a client business unit of the second service provider business unit for the second shared business function.

14. The apparatus of claim 4, wherein the instructions for providing a shared services model comprise:
instructions for providing a user interface; and
instructions for receiving, via the user interface, user input for defining one or more components of the shared services model.

15. The apparatus of claim 4, wherein the set of instructions further comprises:
instructions for outputting a record of the one or more accounting entries.

16. The apparatus of claim 4, wherein the plurality of client business units comprises a first client business unit having a service level agreement that specifies a budgeted rate for the shared business function, and wherein the instructions for allocating the cost of the shared business function among the plurality of client business units comprises allocating a portion of the cost of the shared business function to the first client business unit according to the budgeted rate specified by the service level agreement.

17. The apparatus of claim 4, wherein the instructions for allocating the cost of the shared business function among the plurality of client business units comprises dividing the cost among the plurality of client business units proportional to each client business unit's amount of use of the shared business function.

18. The apparatus of claim 4, wherein the plurality of client business units comprises a first client business unit, and wherein the instructions for performing one or more accounting entries in the enterprise application comprise instructions to charge the first client business unit an amount equal to an actual cost of a set of transactions processed on behalf of the first client business unit.

19. The apparatus of claim 4, wherein the plurality of client business units comprises a first client business unit, and wherein the instructions for performing one or more accounting entries in the enterprise application comprise instructions to charge the first client business unit an amount equal to an actual cost of a set of transactions processed on behalf of the first client business unit plus a specified markup.

20. The apparatus of claim 4, wherein the instructions for performing one or more accounting entries in the enterprise application comprise instructions to post the one or more accounting entries to a general ledger account.

21. The apparatus of claim 4, wherein the instructions for performing one or more accounting entries in the enterprise application comprise instructions to post the one or more accounting entries to a specified cost recovery account associated with the service provider business unit and one or more specified cross charge accounts associated with the one or more of the plurality of client business units.
